(19) United States
(12) Patent Application Publication
(10) Pub. No.: US 2013/0268233 A1
(43) Pub. Date: Oct. 10, 2013

(54) METHOD FOR OPERATING AN ALIGNMENT HEAD SYSTEM

(71) Applicant: Allan Todd, Edinburgh (GB)

(72) Inventor: Allan Todd, Edinburgh (GB)

(21) Appl. No.: 13/880,276

(22) PCT Filed: Oct. 19, 2010
(86) PCT No.: PCT/EP2010/006359

§ 371 Date: Jun. 27, 2013

(51) Int. Cl. G01B 11/14

(52) U.S. Cl. CPC G01B 11/14
USPC 702/150

(57) ABSTRACT

In a method for operating an alignment head system (1) which is configured to take alignment data with respect to a pair of shafts (4, 5) coupled to each other by means of a coupling (6), data indicative of the alignment of the shafts (4, 5) with respect to each other are taken. A value indicative of the accuracy with which the data allows an estimation of the alignment of the two shafts (4, 5) with respect to each other is determined, and a predefined action in response to the determined value is carried out.

### FIELD OF THE INVENTION

The invention relates to a method for operating an alignment head system.

### DESCRIPTION OF THE RELATED ART

U.S. Pat. No. 5,684,578 discloses a laser alignment head system for taking alignment data with respect to a pair of coupled shafts. The alignment head system comprises two laser alignment heads, a central telemetry unit and a shaft alignment analyzer. Each alignment head includes a laser, a laser sensor, an angle sensor, a computer, and a transmitter for transmitting data from the laser alignment head. During operation, each computer produces output data corresponding to the position and rotational angle of its associated shaft. The relevant transmitter transmits the output data wirelessly to the central telemetry unit coupled to the shaft alignment analyzer.

### SUMMARY OF THE INVENTION

It is an object of the present invention to provide an improved method for operating an alignment head system.

The object is achieved in accordance with the invention by means of a method for operating an alignment head system which is configured to take alignment data with respect to a pair of shafts coupled to each other by means of a coupling, comprising the steps of:
utilizing the alignment head system, taking data indicative of the alignment of the shafts with respect to each other,
determining a value indicative of the accuracy with which the data allows an estimation of the alignment of the two shafts with respect to each other, and
carrying out a predefined action in response to the determined value.

According to the inventive method, the alignment head system, which particularly may be a laser alignment head system, gathers data indicative of the alignment or misalignment of the two shafts. In order, for instance, to assure a certain quality or accuracy of the determined alignment based on the data, they are analyzed in order to determine the quality or the accuracy with which the data allow to determine the alignment of the shafts with respect to each other. Then, certain actions are carried out in response to the determined quality or accuracy which is reflected by the determined value.

Depending on the value, more data indicative of the alignment of the shafts may be taken automatically. This may improve the accuracy with which the alignment or misalignment of the two shafts, with respect to each other, can be determined. Alternatively or additionally, a warning may be issued. The warning may be issued acoustically and/or optically. Then, a user of the alignment head system may change the conditions for the measurement or may postpone the measurement until better conditions are available.

According to one variant of the inventive method, the following further steps may be carried out:
detecting a light beam on a detector of an alignment head of the alignment head system,
obtaining, based on the detected light beam, a plurality of N estimates dₙ each indicative of the alignment of the shafts with respect to each other, and
determining the value based on an estimation of the accuracy of the plurality of estimates.

The alignment head system may particularly comprise two alignment heads, one mounted on one of the shafts and the other mounted on the other shaft. For taking the data, one of the alignment heads may be equipped with a light source emitting the light beam. The light source may particularly be a laser so that the light beam is a laser beam. The other alignment head may comprise the detector which may be a CCD, CMOS or PSD detector. It is also possible for the other alignment head to comprise a reflector to reflect the light beam and for the alignment head which comprises the light source to comprise the detector. The detector receives the light beam and produces corresponding electrical signals associated with the data indicative of the alignment of the two shafts with respect to each other. According to this embodiment, the electric signals are used to obtain the plurality of estimates each indicative of the alignment. Then, it is possible, for instance, to average the individual estimates in order to obtain an averaged estimate reflecting the alignment of the two shafts with respect to each other with improved accuracy. Then, depending on the embodiment, the accuracy or quality of the individual estimates dₙ may be analyzed and, in response to this analysis, more estimates dₙ may be obtained to improve accuracy of the averaged estimate. This may be continued, until a pre-defined accuracy is reached and/or until a maximal number of estimates dₙ is reached.

In order to obtain the value indicative of the accuracy with which the data allow an estimation of the alignment of the two shafts with respect to each other, the kurtosis of a graph related to the plurality of estimates, the range of the plurality of estimates (max−min), and/or the standard deviation of the plurality of estimates may be determined.

Particularly, when utilizing the standard deviation, the standard deviation s_{N} may be calculated according to

$${S}_{N} = \sqrt{\frac{1}{N - 1} {\sum }_{n = 1}^{N} {( {d}_{n} - \overline{d} )}^{2}}$$

wherein d̅ is calculated according to

$$\overline{d} = \frac{1}{N} {\sum }_{i = 1}^{N} {d}_{n} ,$$

which is the averaged estimate reflecting the alignment of the two shafts with respect to each.

At least one more estimate dₙ indicative of the alignment of the shafts may be obtained in response to the value. Then, the accuracy of the averaged estimate may improve.

In one variant of the inventive method, the plurality of N estimates are a plurality of deflection estimates dₙ each indicative of the deflection between the two centers of the shafts. The deflection estimates, particularly utilizing the light beam and the detector, can be obtained relatively easily. For this embodiment, in particular one image from the detector or sensor is captured, a single deflection value is calculated, and then this process is repeated a number of times. Then, the averaging is applied to the deflection values calculated.

In order to improve the accuracy of the deflection estimates dₙ, the deflection estimates dₙ may be estimated as a geometrically-weighted averaging of signals generated by the detector in response of detecting the profile of the light beam.

The individual deflection estimate dₙ may in particular be estimated as a centroid y_{centroid} of the detected profile of the light beam. The centroid y_{centroid} may be calculated according to:

$${y}_{centro id} = \frac{\sum y \cdot V ( y )}{\sum V ( y )}$$

wherein y is the distance at which the detector detects the profile of the light beam with reference to the line center onto which the shaft the alignment head holding the detector is attached, and V(y) is the corresponding value of the detected light beam on the detector.

When plotting the V(y) function used to calculate the centroid y_{centroid} value, the y-axis, running up and down the graph, may represent the distance at which the light beam, particularly the laser, hits the detector and thus can be seen as a measurement of the movement of the light source or the laser relative to the center of the shaft on which the detector is mounted, while the x-axis, running across the graph, shows V(y) which is the value of the light or laser signal seen at the corresponding y-offset on the detector.

Utilizing the centroid calculation, or a similar geometrically-weighted averaging techniques, allows to estimate the location of the peak of the light or laser beam on the detector to better than 1 pixel accuracy. This provides a value for the ‘center of gravity’ of the beam profile on the sensor or detector, and allows for detecting deflections with better precision than the pixel size of the sensor or detector, since the beam is normally considerably wider than the pixel size and so its overall shape, rather than just the peak, provides information about the deflection measurement. Once the beam has moved, the centroid value may be recalculated and the difference between the two values is directly proportional to the distance moved.

### BRIEF DESCRIPTION OF THE DRAWINGS

FIG. 1 is a laser alignment head system.

FIG. 2 is a schematic block diagram of the alignment heads of the alignment head system.

FIG. 3 is a graph illustrating a signal V(y) as a function of distance y.

### DESCRIPTION OF EMBODIMENTS

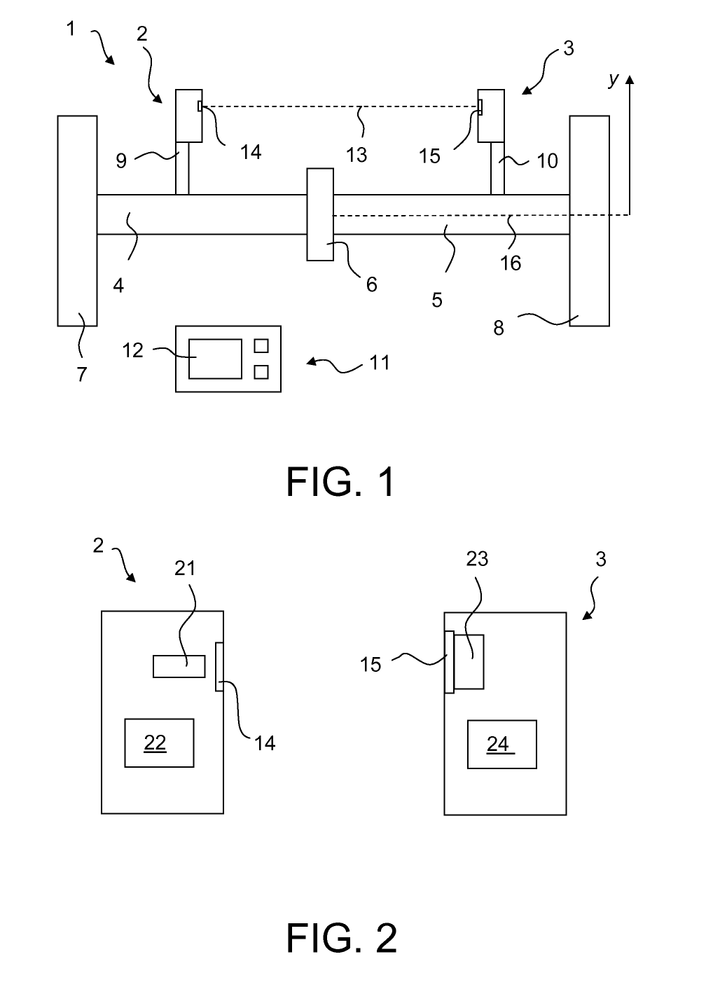

FIG. 1 shows a laser alignment head system 1 comprised of first and second laser alignment heads 2, 3. FIG. 2 depicts a schematic block diagram of the two laser alignment heads 2, 3.

The laser alignment head system 1 is configured to take alignment data with respect to a pair of shafts 4, 5 coupled to each other by means of a coupling 6. The shafts 4, 5 are connected to respective machines 7, 8, such as a motor driving, for instance, a pump through the coupling 6. The first and second laser alignment heads 2, 3 are mounted on the shafts 4, 5, for instance, by means of appropriate mounting systems 9, 10, as it is generally know in the art.

The alignment head system 1 further comprises a data acquisition and calculation device configured to receive and process data from the laser alignment heads 2, 3. The data acquisition and calculation device may be a computer 11 which includes a processor 12. The alignment head system 1 may particularly be configured such that the computer 11 wirelessly receives the data from the laser alignment heads 2, 3.

For the example embodiment shown and as depicted in FIG. 2, the first laser alignment head 2 comprises a laser 21 configured to generate a laser beam 13 which emanates from the first laser alignment head 2 through an aperture 14. The laser 21 is connected to a processor 22 which controls the laser 21 during operation. The first laser alignment head 2 may be mounted on its shaft 4 such that the laser 21 has a pre-defined or known distance from the center of the shaft 4.

The second alignment head 3 comprises a detector window 15 through which the laser beam 13 emitted by the first laser alignment head 2 penetrates. The second alignment head 3 further comprises a detector 23 behind the detector window 15. The detector 23 is particularly a CCD, CMOS or PSD-Sensor, is configured to receive the laser beam 13 and is connected to a processor 24. The processor 24 gathers and processes data or signals generated by the detector 23 and transmits the processed data to the data acquisition and calculation device.

For the example embodiment shown, the detector 23 comprises at least one row of detector elements which are also referred to as pixels. The second alignment head 3 is mounted on its shaft 5 so that the at least one row of pixels of the detector 23 extends in a radial direction y relative to the shaft 5 or its center line 16. During operation, the shafts 4, 5 are rotated and the laser 21 hits pixels of the detector 23 corresponding to the deflection d of the two shafts 4, 5 relative to each other.

During operation, the detector 23 generates electrical signals in response to the detected laser beam 13. The processor 24 of the second alignment head 2 or the computer 11 may be configured to calculate, based on the electric signals of the detector, a plurality N of deflection estimates dₙ.

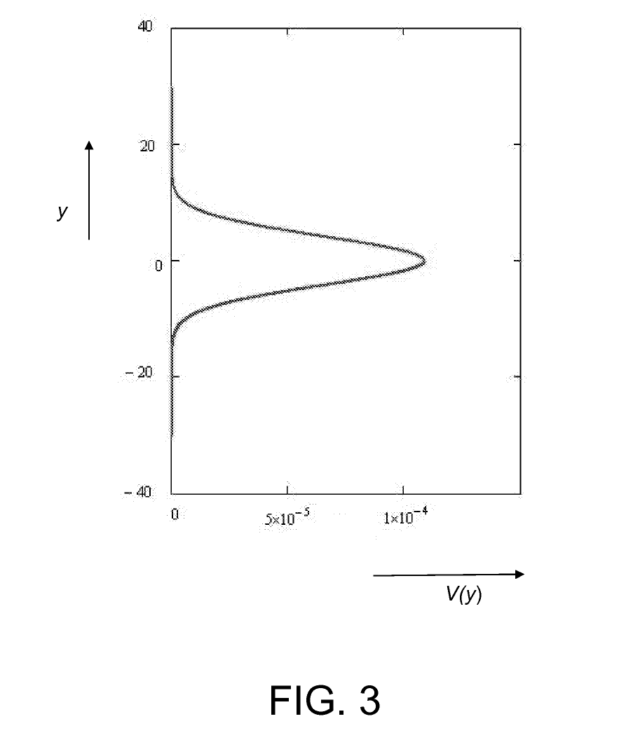

For the example embodiment described, the individual deflection estimates dₙ are calculated using the centroid y_{centroid} of the detected laser profile on the detector 23. Since the laser beam 13 is normally considerably wider than the pixel size of the detector 23, its overall shape, rather than just the peak, provides information about the deflection d. FIG. 3 shows the laser signal V(y) as a function of the distance y with which the detector 23 detects the profile of the laser 21. For the example embodiment shown, the distance y is taken as an offset on the detector 23. The centroid y_{centroid} is calculated as and corresponds to the deflection dᵢ:

$${y}_{centro id} = \frac{\sum y \cdot V ( y )}{\sum V ( y )}$$

For the embodiment described, several detector 23 readings, i.e. several deflection estimates dₙ are obtained and averaged. The averaged deflection estimate d̅ may be calculated as following:

$$\overline{d} = \frac{1}{N} {\sum }_{n = 1}^{N} {d}_{n}$$

wherein N is the number of detector 23 readings or averages, and for the present embodiment the number of centroid calculations.

Assuming that the measured value, i.e. the individual deflection estimates dₙ, in each case has a component due to the actual deflection d and a component due to noise ε then as the deflection d is constant and the noise ε is random the averaged reading, i.e. the averaged deflection estimate d̅, becomes closer to the actual deflection d value as the number of readings N averaged increases:

$$\overline{d} = \frac{1}{N} {\sum }_{n = 1}^{N} ( d + {ɛ}_{n} ) = d + \frac{1}{N} {\sum }_{n = 1}^{N} {ɛ}_{n} \to d as \frac{1}{N} {\sum }_{n = 1}^{N} {ɛ}_{n} \to 0$$

The information content of ε includes information about the measurement process, in particular how noisy it is.

In order to assess the accuracy of the measurement, the computer 11 is configured to use statistical processes or methods to assess the noisiness of the combined signal (d+ε), i.e. the signals dₙ. These statistical methods may be

The kurtosis of the measurements,

the range (max−min) of the measurements, and

particularly the standard deviation of the measurements.

For the example embodiment, the accuracy of the deflection estimates dₙ is determined based on the standard deviation.

For the example embodiment described, the standard deviation for a set of readings, i.e. for a plurality of N deflection estimates dₙ is estimated using the sample standard deviation s_{N}:

$${S}_{N} = \sqrt{\frac{1}{N - 1} {\sum }_{n = 1}^{N} {( {d}_{n} - \overline{d} )}^{2}}$$

In some embodiments the population standard deviation can be used instead (division by N instead of by (N−1))

For the example embodiment described, the statistical measurement of the noisiness of the deflection d reading is used for at least one of the following:
dynamic setting of averaging period,
detection of unacceptably high vibration or noise,
detection of changes in conditions.

In order to improve the accuracy of the measured or averaged deflection estimation d̅ particularly in a noisy environment, more averages can be used. This, however, increases the time to perform the measurement. For the example embodiment shown, the noisiness of the measurement, for instance, determined as described above, is used to automatically adjust the number N of averages, i.e. the number deflection estimates dₙ. For instance, for an initial reading a relative low number N of averages is used, resulting in a relative fast response. The initial number N of readings may be five.

If the estimated noisiness of the signal is unacceptably high, as estimated by the computer 11 utilizing, for instance, the standard deviation as described above, the number N of readings or averages is automatically increased. This may be repeated until either the estimated noisiness is within acceptable limits or some maximum number N of averages is reached.

Alternatively or additionally, the alignment head system 1 may be configured to automatically issue a warning, if the estimated noisiness of the measurement is unacceptably high. Then, the user may take one of several courses of action, for example:
select a higher number N of reading or averages, if the number N of averages is not set dynamically as described above,
remove a cause of vibration, for instance, turn off a nearby machine which is running,
shade the detector 23 to reduce ambient light,
abandon the alignment procedure until better conditions can be arranged, for instance, during a general plant shutdown,
continue with the alignment process but treat the results with caution.

It may be possible to prevent the user from storing alignment measurements if the noisiness of the measurement is unacceptably high. This may help the user to collect high-quality alignment measurements.

Alternatively or additionally the accuracy estimation can be used to detect changes in measuring or surrounding conditions. If the estimated noisiness of the measurement increases noticeably during an alignment process, then the user can be warned that conditions have changed.

Although modifications and changes may be suggested by those skilled in the art, it is the intention of the inventors to embody within the patent warranted hereon all changes and modifications as reasonably and properly come within the scope of their contributions to the art.

### LIST OF REFERENCE SIGNS

1 laser alignment head system

2, 3 laser alignment head

4, 5 shaft

6 coupling

7, 8 machine

9, 10 mounting system

11 computer

12 processor

13 laser beam

14 aperture

15 detector window

16 center line

21 laser

22 processor

23 detector

24 processor

y distance

1. A method for operating an alignment head system configured to take alignment data with respect to a pair of shafts coupled to each other by means of a coupling, comprising the steps of:
utilizing the alignment head system, taking data indicative of the alignment of the shafts with respect to each other,
determining a value indicative of the accuracy with which the data allows an estimation of the alignment of the two shafts with respect to each other, and
carrying out a predefined action in response to the determined value.

2. The method of claim 1, further comprising, in response to the value, automatically taking more data indicative of the alignment of the shafts and/or issuing a warning particularly acoustically and/or optically.

3. The method of claim 1, further comprising
detecting a light beam, particularly a laser beam at a detector of an alignment head of the alignment head system,
obtaining, based on the detected light beam, a plurality of N estimates dₙ each indicative of the alignment of the shafts with respect to each, and
determining the value based on an estimation of the accuracy of the plurality of estimates.

4. The method of claim 3, further comprising determining the value by estimating the kurtosis of a graph related to the plurality of estimates, the range of the plurality of estimates, and/or the standard deviation of the plurality of estimates.

5. The method of claim 4, wherein the standard deviation s_{N} is calculated according to
$${S}_{N} = \sqrt{\frac{1}{N - 1} {\sum }_{n = 1}^{N} {( {d}_{n} - \overline{d} )}^{2}}$$
wherein d̅ is calculated according to
$$\overline{d} = \frac{1}{N} {\sum }_{n = 1}^{N} {d}_{n}$$

6. The method of claim 3, further comprising at least one more estimate dₙ indicative of the alignment of the shafts in response to the value.

7. The method of claim 3, wherein the plurality of N estimates are a plurality of deflection estimates dₙ each indicative of the deflection between the two centers of the shafts.

8. The method of claim 7, further comprising estimating the deflection estimates dₙ as a geometrical-weighted averaging of signals generated by the detector in response of detecting the profile of the light beam.

9. The method of claim 8, further comprising estimating the deflection estimate dₙ as a centroid y_{centroid} of the detected profile of the light beam.

10. The method of claim 9, wherein the centroid y_{centroid} is calculated according to:
$${y}_{centro id} = \frac{\sum y \cdot V ( y )}{\sum V ( y )}$$
wherein y is the distance at which the detector detects the profile of the light beam with reference to the line center of the shaft the alignment head holding the detector is attached to, and V(y) is the corresponding value of the detected light beam on the detector.

11. A method of determining the displacement, the deflection estimates dₙ as a geometrical-weighted averaging of signals generated by the detector in response of detecting the profile of the light beam.

12. The method of claim 11, comprising determining the deflection estimate dₙ as a centroid y_{centroid} of the detected profile of the light beam.

13. The method of claim 12, wherein the centroid y_{centroid} is calculated according to:
$${y}_{centro id} = \frac{\sum y \cdot V ( y )}{\sum V ( y )}$$
wherein y is the distance at which the detector detects the profile of the light beam with reference to the line center of the shaft the alignment head holding the detector is attached to, and V(y) is the corresponding value of the detected light beam on the detector.
